(19) United States
(12) Patent Application Publication
(10) Pub. No.: US 2015/0111185 A1
(43) Pub. Date: Apr. 23, 2015

(54) INTERACTIVE EMOTIONAL COMMUNICATION DOLL

(71) Applicants: Paul Laroche, Miami, FL (US); Sylvia Catello, Trafford, PA (US); Jennifer Nardozzi, Coral Gables, FL (US)

(72) Inventors: Paul Laroche, Miami, FL (US); Sylvia Catello, Trafford, PA (US); Jennifer Nardozzi, Coral Gables, FL (US)

(21) Appl. No.: 14/059,174

(22) Filed: Oct. 21, 2013

(51) Int. Cl. G09B 5/04

(52) U.S. Cl. CPC G09B 5/04
USPC 434/236

(57) ABSTRACT

An interactive emotion communication doll used to evaluate the behavioral health of a child. One embodiment of the present invention can include a substantially humanoid figure defining a continuous exterior surface, wherein the figure further includes a substantially hollow interior, a plurality of receiving sites fixedly attached to the exterior surface of the figure, a plurality of removably attachable indicia sized and configured to selectively engage the receiving sites of the exterior surface of the figure, and a storage compartment for housing the plurality of removably attachable indicia. Another embodiment might include a battery operated RFID tracking system, including a RFID reader embedded in the interior of figure capable of reading RFID tags, having unique identifiers, embedded in the plurality of removably attachable indicia, to be used to track, calculate and evaluate data obtained using the RFID tracking system and therefore better assess the behavior health needs of a child.

### CROSS REFERENCE TO RELATED APPLICATIONS

(Not Applicable).

### STATEMENT REGARDING FEDERALLY SPONSORED RESEARCH OR DEVELOPMENT

(Not Applicable).

### THE NAMES OF THE PARTIES TO A JOINT RESEARCH AGREEMENT

(Not Applicable).

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

(Not Applicable).

### BACKGROUND OF THE INVENTION

1. Field of Invention

The present invention relates to the field of interactive emotional/behavioral health apparatuses, specifically, interactive emotion communication dolls used to evaluate and enhance the emotional health of a child.

According to a 2010 report from the Substance Abuse and Mental Health Administration, one (1) in five Americans experienced some sort of mental illness in 2010 and about five percent (5%) of Americans have suffered from such severe mental illness that it interfered with day-to-day school, work or family.

Based on the National Research Council and Institute of Medicine report (Preventing mental, emotional, and behavioral disorders among young people: progress and possibilities, 2009) that gathered findings from previous studies, it is estimated that thirteen to twenty percent (13%-20%) of children living in the United States (up to 1 out of 5 children) experience a mental disorder in a given year and an estimated $247 two hundred and forty seven billion dollars ($247,000,000,000.00) is spent each year on childhood mental disorders. Because of the impact on children, families, and communities, children's mental disorders are an important public health issue in the United States.

Children present a unique challenge to behavioral healthcare providers in that many times a child cannot express his or her emotional status effectively through verbal communication alone. Behavior healthcare providers have been aware of this challenge and have observed that many times it is the non verbal communication expressed through playing with inanimate objects that speaks volumes in a raw and inhibited manner that helps to shed light on the innermost emotions the child has in a way that the child is not otherwise capable of expressing themselves.

The use of emotional expression toys in the child behavioral healthcare industry to capture the child's most intimate emotions and in doing so assess the child's behavioral health has provided yet another challenge to the child behavior healthcare provider, to wit, how can a single inanimate “toy” serve as a one size fits all behavior healthcare evaluation device for the entire population of children dealing with the myriad of behavior health related problems.

The mass marketplace lacks products that help children express, understand, and manage their emotions. Dolls that currently exist in the market are extremely limited. There are some plush toys that deal with emotions, but each toy has a fixed expression. Importantly, the dolls currently on the market don't have the capacity for interaction with the child. Inadequacies in these dolls diminish the impact a doll can have on the child's development as well as limit the parents' understanding of their child's emotional state.

In order to address the void in the current marketplace for interactive emotional behavior health related evaluative tools, the inventors have invented the present invention, specifically, an interactive emotion communication doll used to evaluate the behavioral health of a child.

An objective of the present invention is to provide an interactive emotional behavior health related evaluative tool to assist the evaluation of the behavior mental health of a child.

Another objective of the present invention is to provide an evaluative tool that is fun to play with from a child's point of view.

Yet another objective of the present invention is to provide an evaluative tool that addresses the needs of a diverse group of children with respect to, inter alia, the cultural and education related background of the child.

Still another objective of the present invention is to provide an evaluative tool that accommodates the range of emotional and behavioral related feelings the child is experiencing using a plurality of emotional communicative indicia, wherein each of the plurality of emotional communicative indicia includes a unique identifier capable of being tracked for the purposes of developing a metric for calculating and then evaluating the resulting data from the various combinations of the emotional communicative indicia, in order to best address the needs of each child from the standpoint of a behavior healthcare professional.

Information relevant to attempts to address these objectives can be found in previous attempts to address the foregoing problems specifically U.S. Pat. No. 6,540,518 and U.S. Pat. No. 5,848,900. However, the foregoing reference suffers from one or more of the following disadvantages: the referenced dolls do not have a user friendly way of storing the emotion communicative indicia when they are not being used and there is no way to track and evaluate using a remotely activated evaluative system with a customized evaluative protocol.

In light of the above, it would be beneficial to have an interactive emotion communicative doll comprising essentially of a doll figure having a plurality of emotional communicative indicia wherein each of the plurality of emotional communicative indicia have unique identifiers that can be tracked and data can be calculated and evaluated based on the data resulting from the various combinations of the plurality of emotional communicative indicia wherein said data is used to evaluate the behavioral health of a child.

### SUMMARY OF THE INVENTION

The present invention is directed towards the field of interactive behavioral health devices, specifically, interactive emotion communication dolls used to evaluate the behavioral health of a child.

One embodiment of the present invention can include a substantially humanoid figure defining a continuous exterior surface, wherein the figure further comprises of a substantially hollow interior, a plurality of receiving sites fixedly attached to the exterior surface of the figure, a plurality of removably attachable indicia sized and configured to selectively engage the receiving sites of the exterior surface of the figure, and a storage compartment for housing the plurality of removably attachable indicia.

Another embodiment of the present invention can include a battery operated RFID reader embedded in the interior of figure capable of reading RFID tags, having unique identifiers, embedded in the plurality of removably attachable indicia.

Another embodiment of the present invention can include an interaction sensor, wherein the interaction sensor is capable of producing a predetermined output in response to the sensor's detection that an interaction has occurred. That embodiment that might further include a speech output module programmed to produce a predetermined speech output in response to the detection that an interaction has occurred. Still another embodiment of the present invention might further include a recording module capable of recording sound and the information obtained by the RFID reader to be used to track, calculate and evaluate data obtained using the RFID tracking system. It is envisioned that RFID tracking system would comprise essentially of a small single board computer that is capable of running lightweight operating systems, a microphone, speaker and amplifier system in electronic communication with the single board computer, a mini Wi-Fi connection in electronic communication with the single board computer, a Passive infrared (PIR) sensor used to detect motion, and a portable rechargeable power source.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a front plan view of one embodiment of the device with a partial cut away view that is useful for understanding the inventive concepts disclosed herein.

FIG. 2 is a front plan view of one embodiment of the device with exemplars of the emotion communicative indicia removably attached thereto;

FIG. 3 is a rear plan view of one embodiment of the device with the storage compartment in plain view;

FIG. 4 is a side elevation view of one embodiment of the device with the storage compartment in plain view;

FIG. 5 is a perspective view of one embodiment of the storage compartment with exemplars of the emotion communicative indicia in plain view;

FIG. 6A is a front plan view of one embodiment of an exemplar of one of the emotion communicative indicia;

FIG. 6B is a rear plan view of one embodiment of an exemplar of one of the emotion communicative indicia; and

FIG. 7 is a diagram of the interaction between the device, the RFID Network and the behavior healthcare provider.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

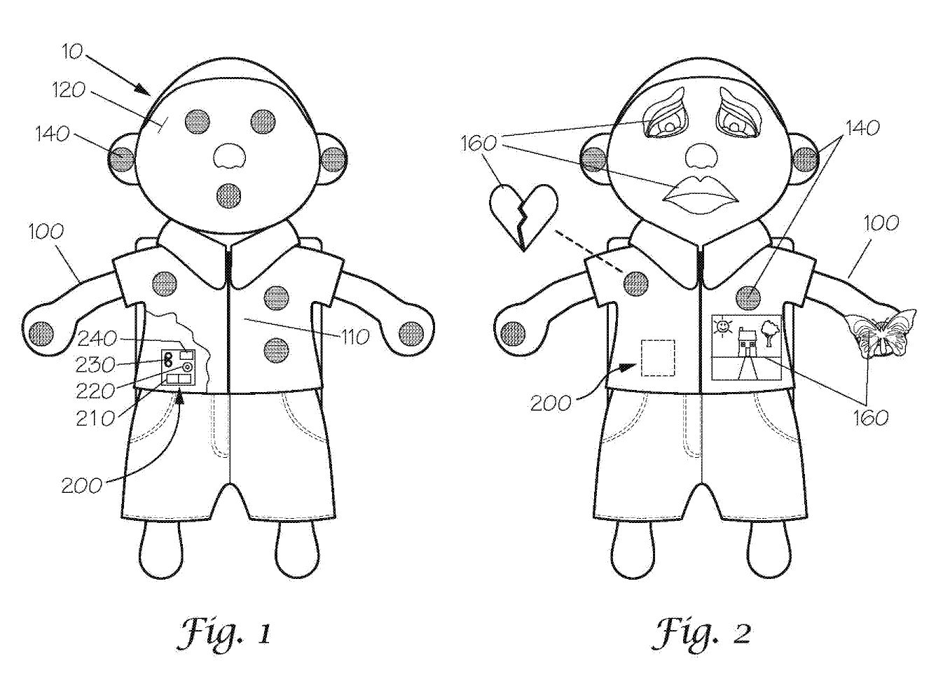

For purposes of this description, the terms “upper,” “bottom,” “right,” “left,” “front,” “vertical,” “horizontal,” and derivatives thereof shall relate to the invention as oriented in FIG. 1.

The present invention is directed towards the field of interactive behavioral health apparatuses, specifically, interactive emotion communication dolls used to evaluate the behavioral health of a child.

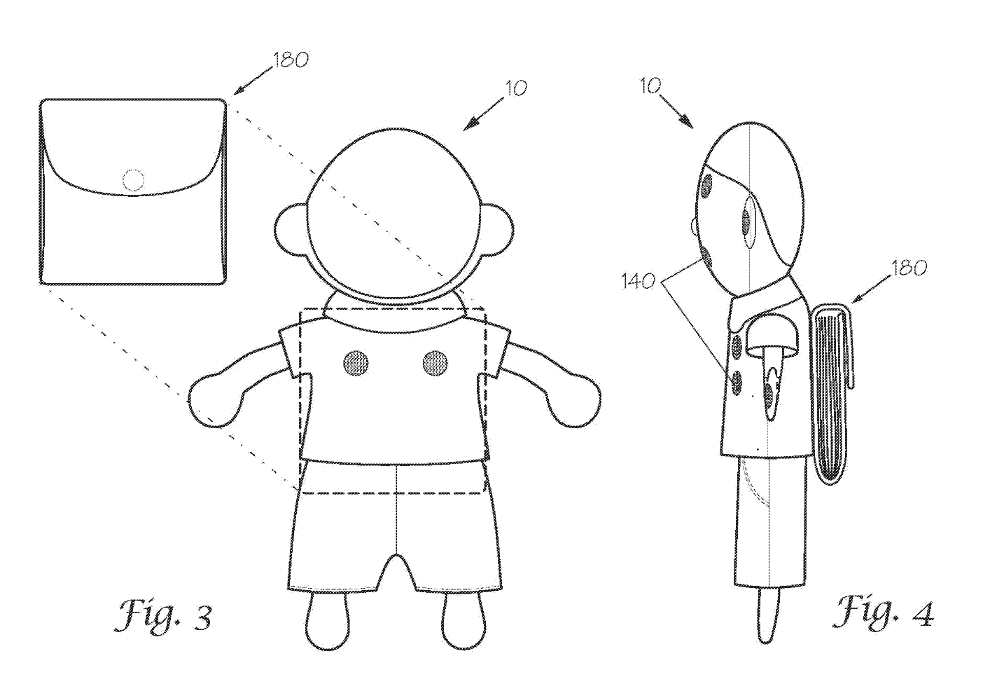

FIGS. 1 and 3 depicting the front and back plan views of the device 10 illustrate one embodiment of the device 10, which is useful for understanding the inventive concepts described herein. As shown, the device 10, according to one embodiment, can include a substantially humanoid figure 100 defining a continuous exterior surface 120, wherein the figure 100 further comprises of a substantially hollow interior 110. The figure 100 even further comprises of a plurality of receiving sites 140 fixedly attached to the exterior surface of the figure 100, a plurality of removably attachable indicia 160 sized and configured to selectively engage the receiving sites 140 of the exterior surface 120 of the figure 100 and a storage compartment 180 for housing the plurality of removably attachable indicia 160.

As described herein, the substantially humanoid figure 100, may be a plush doll of a predetermined material such as, for example, cotton or a cotton blend and stuffed with a cotton or cotton and synthetic material blend. While the dimensions of the substantially humanoid figure 100 are not critical, in the preferred embodiment, the substantially humanoid figure would have a length about its “head to toe” vertical axis of about 24 inches. Of course any number of shapes and dimensions are also contemplated. In one embodiment, it is envisioned that the substantially humanoid figure 100 might include animal like features while other embodiments contemplate figures that might include robot like features or automobile like features. As previously mentioned it is envisioned that the figure 100 may be composed of a cotton, cotton-blend, or fully synthetic composite material, although other fabric like material known in the art may also be used.

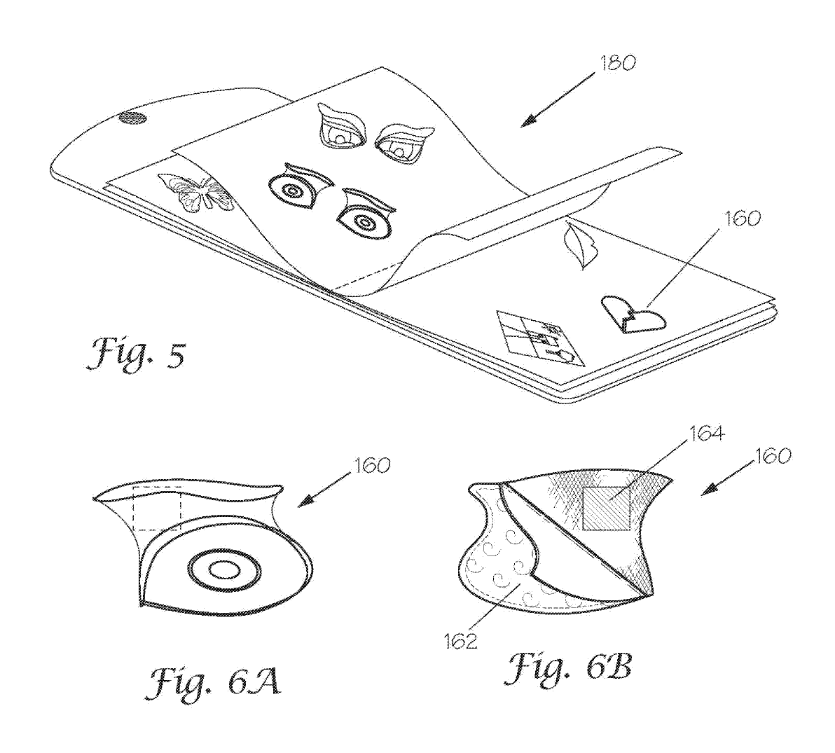

FIGS. 5-6B illustrate various examples of the myriad of emotional communicative indicia 160, each having a connector site 162 sized and configured to engage the receiving site 140 of the exterior surface 120 of the figure 100. As shown in FIG. 5, the emotional communicative indicia 160 cover the entire range of emotional behaviors from happy to sad, from anxious to confident and everything that falls in between on the spectrum of emotional behaviors. It is contemplated that the securing means used to secure the emotional communicative indicia 160 to the receiving site 140 of the exterior surface 120 of the figure 100 might be a hook and loop combination as seen in the hook and loop securing means that is sold under the VELCRO trademark, or the securing means might be a button and loop configuration or the securing means might be a snap-in-place configuration or any combination or reasonable derivation thereof.

As seen in FIGS. 6A-6B the plurality of emotion communicative indicia 160, in addition to having the connector site 162 for securing to the receiving site 140 of the exterior surface 120 of the figure 100, also have an RFID tag 164, having a unique identifier, for communicating with the RFID reader 200 that is embedded in the substantially hollow interior portion 110 of the figure 100. In one embodiment, the device 10 may also include an interaction sensor 210 wherein the interaction sensor 210 is capable of producing a predetermined output in response to the sensor's detection that an interaction has occurred that might further include a speech output module 220 programmed to produce a predetermined speech output in response to the detection that an interaction has occurred. Still another embodiment of the present invention might further include a recording module 230 capable of recording sound and the information obtained by the RFID reader 200 to be used to track, calculate and evaluate data obtained using the RFID tracking system. It is contemplated that the RFID tracking system comprising of a small single board computer that is capable of running lightweight operating systems, a microphone, speaker and amplifier system, in electronic communication with the small single board computer; a RFID reader in electronic communication with the small single board computer, a mini Wi-Fi connection in electronic communication with the small single board computer; a Passive infrared (PIR) sensor used to detect motion in electronic communication with the small single board computer; and a portable rechargeable power source in electronic communication with small single board computer.

It is envisioned that the small single board computer that is capable of running lightweight operating systems, a microphone, speaker and amplifier system, would be similar in function and component composition to that of the small single board computer sold under the trademark, RASPBERRY PI. Those familiar in the art would recognize that the small single board computer currently sold under the trademark, Raspberry Pi, is a small credit card size, inexpensive single-board computer that is capable of running Linux and other lightweight operating systems which run on ARM processors.

It is envisioned that the microphone contained in the RFID tracking system might be equipped with a 20-20 KHz electret microphone. It is also contemplated that an amplifier with similar function and component composition and configuration to that of the amplifier current sold under the trademark Maxim MAX446. One familiar with the art will recognize that the components in the RFID tracking system are not limited to the components used as examples currently marketed under the referenced trademarks, but rather those references were merely for exemplars of functionally and component composition and configurally similar components known in the art; however, any other component with similar function, component composition and configuration, may be used as well.

It is envisioned that the RFID reader might be a very simple to use RFID reader module similar in function, component composition, and configuration to that the RFID currently known in the art as the RFID Reader ID-20 (125 kHz) with built in antenna. Those familiar in the art would appreciated that once the RFID reader module was powered on, once a card (RFID tag) was placed within range of the RFID reader the module would produce a serial string output containing the unique identifier of the card (RFID tag). A RFID reader module with similar function, component composition and configuration might include the following features 5V supply, 125 kHz read frequency, EM4001 64-bit RFID tag compatible, 9600 bps TTL and RS232 output, magnetic stripe emulation output, read range of 200 mm, with the following physical dimensions: 38 mm×40 mm×7 mm, although variations of these and additional features are also contemplated.

The Internet connection contemplated in the RFID tracking system may access the Internet via connecting the Miniature Wi-Fi (802.11 b/g/n) to the small single board computer. The RFID tracking system may also include a wireless Internet connection that accesses the Internet using a USB port connection that is similar in function, component composition and configuration to the USB port connection currently sold under the trademark Beagle Bone's USB port. Although this application makes reference to a wireless internet connection using the term Wi-Fi, it is to be understood that any number of other wireless internet connection technologies known in the art or similar thereto are also contemplated herein in connection therewith.

It is envisioned that the portable power supply for the device 10 might include rechargeable AA size batteries. One skilled in the art will recognize that AA sized batteries can vary from 1.2V to 1.5V and therefore a voltage regulator will be required to provide a constant and stable 5V to the single board computer. It is contemplated that when a wireless Internet connection is required, 1 A of current will be required.

It is further envisioned that the RFID tracking system 200 and its plurality of RFID tags 164 and the RFID reader 240, will be programmed and configured such that the RFID tracking system 200 will be capable of observing, detecting, recording and evaluating virtually all observable data, surrounding the interaction with the child user and the device 10.

Referring back to FIGS. 1-4, the device 10 also includes a storage compartment 180 for housing the plurality of removably attachable emotional communicative indicia 160. It is envisioned that the storage compartment 180 might resemble a book bag type shoulder strapped bag, although it is also contemplated that the storage compartment 180 might also resemble a traveling suitcase, a work briefcase, a toolbox, a lunch box, as well as any traditional carrying means known to one of ordinary skill in the art.

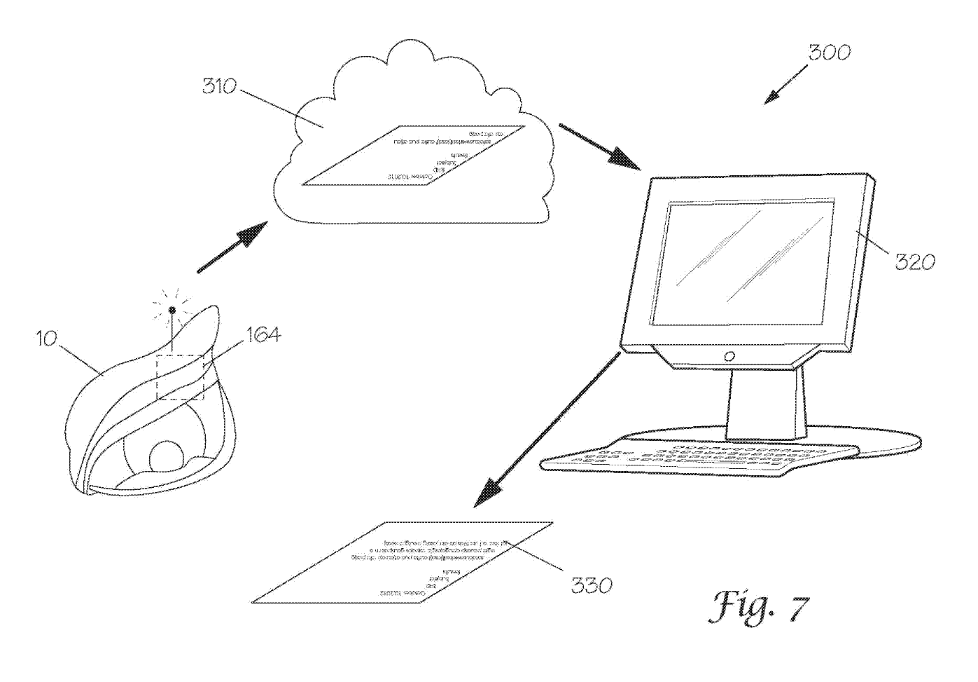

In a preferred embodiment as seen in FIG. 7, the device 10 may also include an RFID network 300 to be used to track, calculate and evaluate data from the plurality of RFID tags 164 and RFID tag tracking system 200 obtained using the RFID tracking system 200. The RFID network 300, includes the device 10, including the plurality of RFID tags 164 and RFID tag tracking system 200, in electronic communication with a hosted Internet web platform 310, at least one computer work station 320 in electronic communication with the hosted Internet web platform 310, thereby having access to the Internet web platform 310, and a RFID data output module 330 in electronic communication with the computer work station 320 so that the healthcare provider can have access to the data obtained through the RFID tracking system 200. One skilled in the art would recognize that all of the components of the RFID network, to wit, the plurality of RFID tags 164, the RFID tag tracking system 200, the hosted Internet web platform 310, the at least one computer work station 320, and the RFID data output module 330 are in electronic communication with each other, wherein said electronic communication may be achieve through hard wire data transfer connections or wireless data transfer connections known in the art or similar variations or derivations thereof. It is further understood that the hosted Internet web platform may be hosted and stored locally at the healthcare provider's facility or remotely using cloud computing solutions known in the art. The at least one computer work station 320, may be a personal desktop computer, a laptop computer, a tablet device, smartphone, or other computing technology known in the art. The RFID data output module 330 may be a printer capable of printing hard copy paper format output or it may a data storage device capable of saving data output in digital format output that may later be printed in hard copy paper format output.

As described herein, the various components are electronically connected using circuitry that is currently known in the art and one of ordinary level of skill in the art would recognize that the circuits could be configured in series or parallel configurations. Although the FIGS. as referenced and described herein, illustrate a closed device 10 wherein the circuitry is hidden from sight within the substantially hollow interior portion 110 of the figure 100, one skilled in the art would recognize that the device 10 could also be constructed with an exposed circuitry without affecting the functionality of the device 10.

In operation, as seen in FIG. 7 the device 10 is given to a child user to play with. The child user is told the device 10 includes a storage compartment 180 containing a plurality of emotional communicative indicia 160 and then the child is asked to create an emotional doll that represents her current emotional state. The child user then chooses the emotional communicative indicia 160 that best correspond to her current emotional state and the child user engages the connector sites 162 of the emotional communicative indicia 160 with the receiving sites 140 of the exterior surface 120 of the figure 100 and the RFID tag, having a unique identifier, and the RFID tag reader system 200 will compute a pre-programmed calculation and evaluate the resulting data obtained through the plurality of RFID tags 164 and the RFID reader system 200. Once the RFID reader system has calculated and analyzed the resulting data, said RFID data is transmitted through the RFID network 300 as seen in FIG. 7 and ultimately to the healthcare provider through the RFID data output module 330. By using the device 10 as described above, the behavior healthcare professional is better equipped to assess the child's behavioral health and therefore provide better, individual behavior health related treatment that is specific to the particular child's behavioral health profile as determined by the child's interaction with the device 10.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An interactive emotion communication apparatus used to evaluate the behavioral health of a child, said apparatus comprising:
a substantially humanoid figure defining a continuous exterior surface, wherein the figure further comprises of a substantially hollow interior;
a plurality of receiving sites fixedly attached to the exterior surface of the figure;
a plurality of removably attachable indicia, having connector sites sized and configured to selectively engage the receiving sites of the exterior surface of the figure; and
a storage compartment for housing the plurality of removably attachable indicia.

2. The apparatus of claim 1, further comprising a battery operated RFID reader embedded in the interior of the figure capable of reading RFID tags embedded in the plurality of removably attachable indicia.

3. The apparatus of claim 1, further comprising an interaction sensor, wherein the interaction sensor is capable of producing a predetermined output in response to the sensor's detection that an interaction has occurred.

4. The apparatus of claim 3, further comprising a speech output module programed to produce a predetermined speech output in response to the detection that an interaction has occurred.

5. The apparatus of claim 1, further comprising a recording module capable of recording sound and the information obtained by the RFID reader.

6. The apparatus of claim 1, further comprising a unique identifier that can be used to track and record interactions detected by the interaction sensor.

7. The apparatus of claim 2, further comprising:
a small single board computer that is capable of running lightweight operating systems;
a microphone, speaker and amplifier system in electronic communication with the single board computer;
a mini Wi-Fi connection in electronic communication with the single board computer;
a Passive infrared sensor to detect motion; and
a portable rechargeable power source.

8. The apparatus of claim 2, further comprising of a RFID network, wherein the RFID network comprises:
a plurality of RFID tags with unique identifiers that can be read by a RFID reader;
a RFID reader in electronic communication with a first computer, wherein said first computer is in electronic communication with the Internet;
a first computer in electronic communication with the Internet;
a hosted Internet web platform accessible by said first computer and thereby establishing electronic communication between said hosted Internet web platform and said first computer;
at least one computer work station in electronic communication with the Internet and the hosted Internet web platform, thereby establishing electronic communication between the first computer, the hosted Internet web platform and the at least one computer work station; and
a RFID data output module in electronic communication with the computer work station so that the healthcare provider can have access to the data obtained through the RFID tracking system.

9. The apparatus of claim 1, wherein the figure is made of a cotton fabric.

10. The apparatus of claim 1, wherein the figure is made of plush material.

11. The apparatus of claim 1, wherein the figure resembles a human being.

12. The apparatus of claim 1, wherein the figure has animal like features.

13. The apparatus of claim 1, wherein the figure has robot like features.

14. An interactive emotion communication apparatus used to evaluate the behavioral health of a child, said apparatus comprising:
a substantially humanoid figure defining a continuous exterior surface, wherein the figure further comprises of a substantially hollow interior, wherein a battery operated RFID reader is embedded in the interior of the figure capable of reading RFID tags embedded in the plurality of removably attachable indicia, wherein each RFID tag has a unique identifier that can be used to track and record interactions detected by the interaction sensor;
a plurality of receiving sites fixedly attached to the exterior surface of the figure;
a plurality of removably attachable indicia, having connector sites sized and configured to selectively engage the receiving sites of the exterior surface of the figure, each of the plurality of removably attachable indicia further comprises of an RFID tag capable of being read by the RFID reader embedded in the interior of the figure;
an interaction sensor, wherein the interaction sensor is capable of producing a predetermined output in response to the sensor's detection that an interaction has occurred;
a speech output module programmed to produce a predetermined speech output in response to the detection that an interaction has occurred;
a Wi-Fi module that allows for the device to communicate with the Internet;
a computer readable medium having instructions for causing a computer evaluate data obtained through the RFID tag and communicate that information to other computers using the Internet; and
a storage compartment for housing the plurality of removably attachable indicia.
